(19) United States
(12) Patent Application Publication
(10) Pub. No.: US 2008/0042627 A1
(43) Pub. Date: Feb. 21, 2008

(54) Voltage feedback circuit for liquid crystal display backlight inverter

(75) Inventors: Sang Cheol Shin, Gyunggi-do (KR); Byoung Own Min, Gyunggi-do (KR); Jung Chul Gong, Seoul (KR); Yu Jin Jang, Gyunggi-do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/819,571

(22) Filed: Jun. 28, 2007

(30) Foreign Application Priority Data
Jun. 29, 2006 (KR) 10-2006-59875

(51) Int. Cl. G05F 1/10

(52) U.S. Cl. 323/234

(57) ABSTRACT

A voltage feedback circuit for a liquid crystal display backlight inverter including a plurality of first and second transformers driven oppositely to each other, the voltage feedback circuit including: a first voltage detector detecting a first drive voltage from a first transformer; a second voltage detector detecting a second drive voltage from a second transformer; a peak detector detecting a peak of a voltage detected at a detection connection node at which an output end of the first voltage detector and an output end of the second voltage detector are connected; a voltage adjustor adjusting a peak voltage from the peak detector according to a predetermined voltage ratio; and anerror detector detecting a difference voltage between the detected voltage from the voltage adjustor and a predetermined reference voltage.

### CLAIM OF PRIORITY

This application claims the benefit of Korean Patent Application No. 2006-0059875 filed on Jun. 29, 2006, in the Korean Intellectual Property Office, the disclosure of which is incorporated herein by reference.

### BACKGROUND OF THE INVENTION

1. Field of the Invention

The present invention relates to a voltage feedback circuit for a liquid crystal display (LCD) backlight inverter applied to an LCD monitor or an LCD television, and more particularly, to a voltage feedback circuit for an LCD backlight inverter, the circuit accurately detecting a drive voltage when a lamp is open, regardless of the number of open wires of the lamp, thereby preventing an over-voltage usually caused when one of a pair of wires is open and obviating destruction of a transformer by the over-voltage.

2. Description of the Related Art

In general, an LCD backlight inverter applied to an LCD monitor or an LCD television has a structure as shown in FIG. 1.

FIG. 1 is a configuration diagram illustrating a general LCD backlight inverter.

The general LCD backlight inverter shown in FIG. 1 includes a controller 1 controlling power switching according to one of a feedback voltage SV and a feedback current SA; a power switch 2 switching power according to the control of the controller 1; a transformer part 3 converting a first voltage supplied by the power switch 2 to a second voltage; a lamp part LAMP including a plurality of lamps turned on by a drive current according to the second voltage of the transformer part 3; a voltage detection circuit part 11 detecting a drive voltage of the lamp part LAMP; a voltage feedback circuit part 12 operating when the lamp part 3 is open and comparing the voltage detected by the voltage detection circuit part 11 with a reference voltage to feed back a difference voltage to the controller 1; a current detection circuit part 21 detecting a current running through the lamp part LAMP; a current feedback circuit part 22 operating during a normal operation of the lamp and comparing a voltage corresponding to the current detected by the current detection circuit part 21 with a reference voltage to feed back a difference voltage to the controller 1; and a lamp-open protection circuit part 30 comparing the voltage corresponding to the current detected by the current detection circuit part 21 and a reference voltage for determining whether the lamp is open or not and outputting a protection signal SP according to the comparison result to the voltage feedback circuit part 12 and the current feedback circuit part 22.

In this case, the lamp-open protection circuit part 30 controls the operation of the voltage feedback circuit part 12 during the normal operation of the lamp part LAMP, and controls the operation of the current feedback circuit part 22 when the lamp part LAMP is open.

As described above, in this case, a voltage feedback circuit detecting the drive voltage of the lamp part LAMP to feed back the detected voltage to the controller, includes the voltage detection circuit part 11 and the voltage feedback circuit part 12, and the transformer part 3 may include a plurality of first and second transformers T1 and T2 supplying drive signals of opposite phase from each other.

Such a conventional voltage feedback circuit will now be explained with reference to FIG. 2.

FIG. 2 is a configuration diagram illustrating a conventional voltage feedback circuit.

The conventionalvoltage feedbackcircuit shownin FIG. 2 includes a first voltage detector 31 detecting a drive voltage V1 from a first transformer T1, a second voltage detector 32 detecting a drive voltage V2 from a second transformer T2, a voltage adjustor 40 adjusting a combined voltage of the detected voltage of the first voltage detector 31 and the detected voltage of the second voltage detector 32 according to a predetermined ratio, and an error detector 50 detecting a difference voltage between a voltage adjusted by the voltage adjustor40 andapredeterminedreferencevoltage andproviding the difference voltage to the controller.

The conventional voltage feedback circuit may be applied to various types of lamps, which will be described with reference to FIGS. 3(a) and 3(b).

FIGS. 3(a) and 3(b) illustrate examples of voltage detection for each lamp type. FIG. 3(a) illustrates a small-size lamp type, in which a first lamp LAMP1 is driven by a first transformer T1 and a second lamp LAMP2 is driven by a second transformer T2. FIG. 3(b) illustrates a large-size lamp type, in which the lamp has one end connected to a first transformer T1 and the other end connected to a second transformer T2. In thiscase, thefirst and secondtransformers T1 and T2 provide first and second drive voltages of opposite phases from each other.

In this case, in the conventional voltage feedback circuit, a voltage as illustrated in FIG. 4 is detected during the normal operation of the lamp.

FIG. 4 is a waveform diagram illustrating a voltage detected during the normal operation of the lamp, in which V1 denotes the first drive voltage by the first transformer T1 and V2 denotes the second drive voltage by the second transformer T2.

In addition, VD denotes a combined detected voltage of a voltage rectified from the first drive voltage V1 and a voltage rectified from the second drive voltage V2, and this combined detected voltage is about 6V during the normal operation of the lamp.

The detected voltage VD of 6V may be adjusted to, for example, 1V by the voltage adjustor 40, and as a result, since the detected voltage VD of 1V is lower than the predetermined reference voltage (e.g. 2V), the open-state determiner 50 may judge that the lamp is in a normal operation state.

On the other hand, in the conventional voltage feedback circuit, a voltage as illustrated in FIG. 5 is detected when the lamp is open.

FIGS. 5(a) and 5(b) illustrate waveforms of a voltage detected when the lamp is open. In FIG. 5(a), the detected voltage of about 2 kV is adjusted to, for example, 300V by the voltage adjustor 40, and as a result, since the detected voltage VD (300V) is higher than the predetermined reference voltage (e.g. 2V), the open-state determiner 50 may judge that the lamp is open.

However, when the lamp is unstably open, that is, one of a pair of lamp wires is open, in which case, the average voltage value detected at the side of the open wire corresponds to a half of the voltage detected when the both wires are open, the controller continuously increases the drive voltage, causing an over-voltage. As a result, the transformer may be fatally damaged by the high voltage.

For example, when only one lamp is open in the circuit illustrated in FIG. 3(a), or when one of the lamp wires is disconnected in the circuit illustrated in FIG. 3(b), a low value of voltage or current is fed back, and therefore, a high drive voltage is supplied as described above.

Therefore, the transformer at the side of the disconnected lamp provides a high drive voltage in FIG. 3 (a), and thus a high voltage of as much as 4KV is detected as shown in FIG. 5 (b). In addition, the transformer at the disconnected side of the lamp provides a high drive voltage in FIG. 3(b), and thus a high voltage of as much as 4KV is detected as shown in FIG. 5(b).

Therefore, as described above, the transformer may be damaged by the high voltage or may even be destroyed in some extreme cases.

### SUMMARY OF THE INVENTION

An aspect of the present invention provides a voltage feedback circuit for an LCD backlight inverter, the feedback circuit accurately detecting a drive voltage of a lamp when the lamp is open, regardless of the number of open wires of the lamp, thereby preventing an over-voltage usually occurring when one of a pair of lamp wires is open and obviating destruction of a transformer by the over-voltage.

According to an aspect of the invention, there is provided a voltage feedback circuit for a liquid crystal display backlight inverter including a plurality of first and second transformers driven oppositely to each other, the voltage feedback circuit including: a first voltage detector detecting a first drive voltage from a first transformer; a second voltage detector detecting a second drive voltage from a second transformer; a peak detector detecting a peak of a voltage detected at a detection connection node at which an output end of the first voltage detector and an output end of the second voltage detector are connected; a voltage adjustor adjusting the peak voltage from the peak detector according to a predetermined voltage ratio; and an error detector detecting a difference voltage between the detected voltage from the voltage adjustor and a predetermined reference voltage.

The first voltage detector may include first and second capacitors connected in series with each other between an output end of the first transformer and a ground; a first diode having an anode connected to a first connection node to which the first and second capacitors are connected, the first diode rectifying a voltage at the first connection node; and a second diode having a cathode connected to the anode of the first diode and an anode connected to the ground.

Thesecond voltagedetector mayinclude third andfourth capacitors connected in series with each other between an output end of the second transformer and a ground; a third diode having an anode connected to a second connection node to which the third and fourth capacitors are connected, the third diode rectifying a voltage at the second connection node; anda fourth diode having a cathode connected to the anode of the third diode and an anode connected to the ground.

The peak detector may include a capacitor connected between the detection connection node and a ground; and a resistor formed on a signal line between the capacitor and an output end.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating a general LCD backlight inverter;

FIG. 2 is a configuration diagram illustrating a conventional voltage feedback circuit;

FIGS. 3(a) and 3(b) illustrate examples of voltage detection for each lamp type;

FIG. 4 is a waveform diagram illustrating a voltage detected during a normal operation of the lamp;

FIGS. 5(a) and 5(b) illustrate waveforms of a voltage detected when the lamp is open;

FIG. 6 is a configuration diagram illustrating avoltage feedback circuit for an LCD backlight inverter according to the present invention;

FIG. 7 is a circuit diagram illustrating apeak detector according to the present invention; and

FIGS. 8(a) and 8(b) illustrate waveforms of a peak voltage of the peak detector according to the present invention.

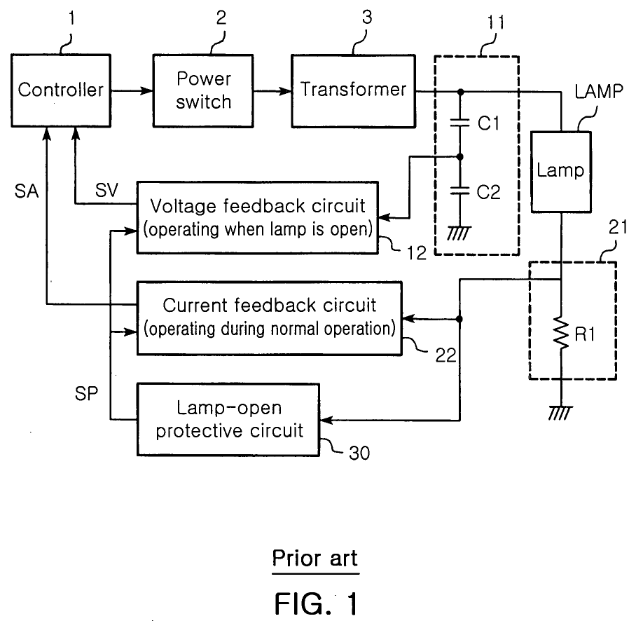

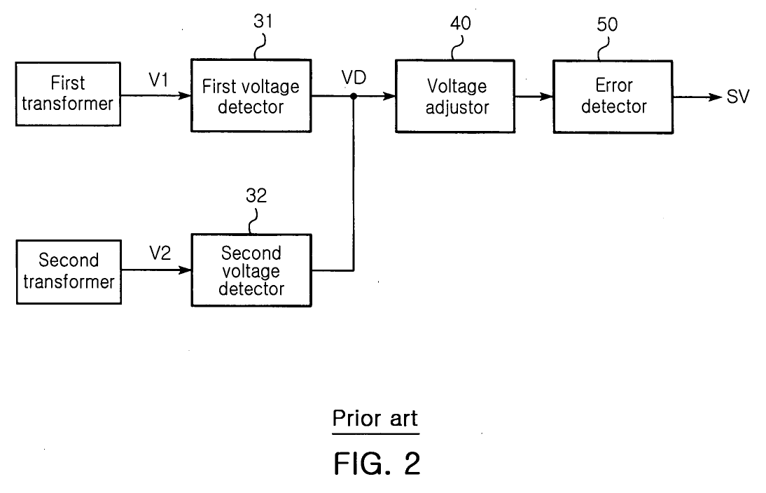

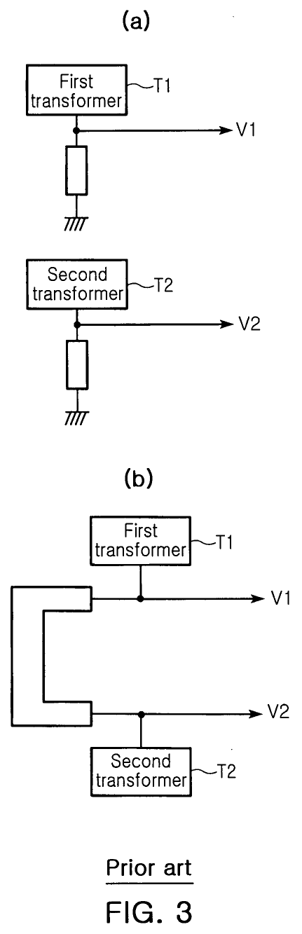

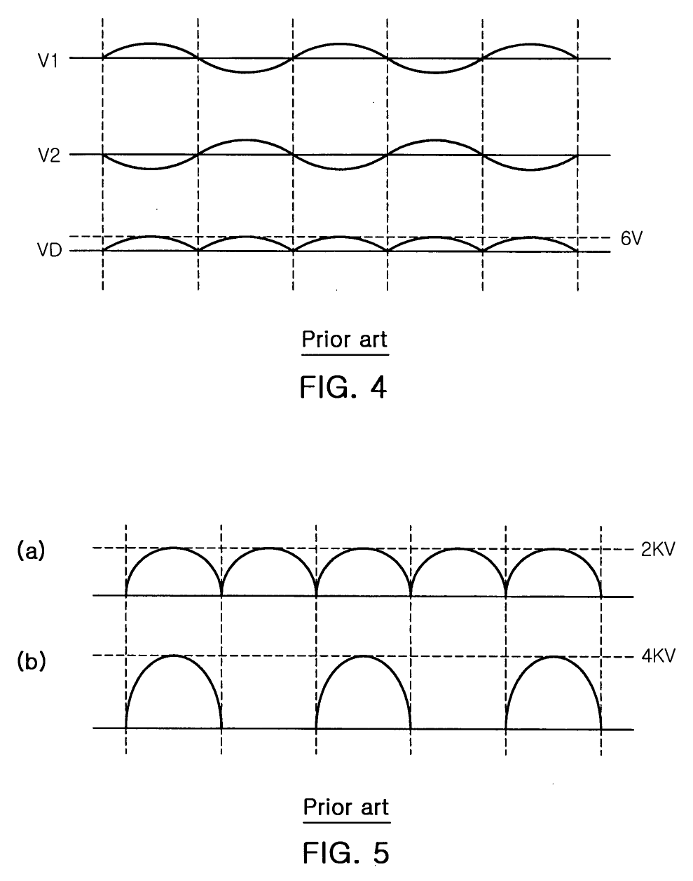

### DETAILED DESCRIPTION OF THE PREFERRED EMBODIMENT

Exemplary embodiments of the present invention will now be described in detail with reference to the accompanying drawings. Inthedrawings, thesamereferencenumeralsareused throughout to designate the same or like components.

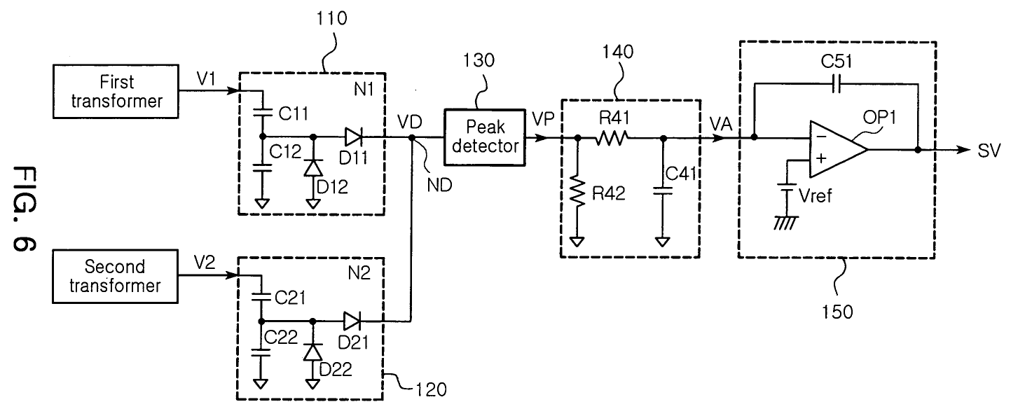

FIG. 6 is a configuration diagram illustrating avoltage feedback circuit for a liquid crystal display (LCD) backlight inverter according to the present invention.

Referring to FIG. 6, the voltage feedback circuit for an LCD backlight inverter according to an exemplary embodiment of the present invention is applied to an LCD backlight inverter including a plurality of first and second transformers T1 and T2 driven oppositely to each other.

The voltage feedback circuit operates when the lamp is open, and includes a first voltage detector 110 detecting a first drive voltage V1 from the first transformer T1; a second voltage detector 120 detecting a second drive voltage V2 from the second transformer V2; a peak detector 130 for detecting a peak of a voltage VD detected at a detection connection node ND to which an output end of the first voltage detector 110 and an output end of the second voltage detector 120 are connected; a voltage adjustor 140 adjusting a peak voltage VP from the peak detector 130 according to a predetermined voltage ratio; and an error detector 150 detecting a difference voltage between an adjusted voltage VA from the voltage adjustor 140 and a predetermined reference voltage Vref.

Thefirst voltagedetector 110 includesfirst andsecond capacitors C11 and C12 connected in series with each other between an output end of the first transformer and a ground; a first diode D11 having an anode connected to a first connection node N1 to which the first and second capacitors C11 and C12 are connected, with the first diode D11 rectifying a voltage at the first connection node N1; and a second diode D12 having a cathode connected to the anode of the first diode D11 and an anode connected to the ground.

The second voltage detector 120 includes third and fourth capacitors C21 and C22 connected in series with each other between an output end of the second transformer and a ground; a third diode D21 having an anode connected to a second connection node N2 to which the third and fourth capacitors C21 and C22 are connected, with the third diode D21 rectifying a voltage at the second connection node N2; and a fourth diode D22 having a cathode connected to the anode of the third diode D21 and an anode connected to the ground.

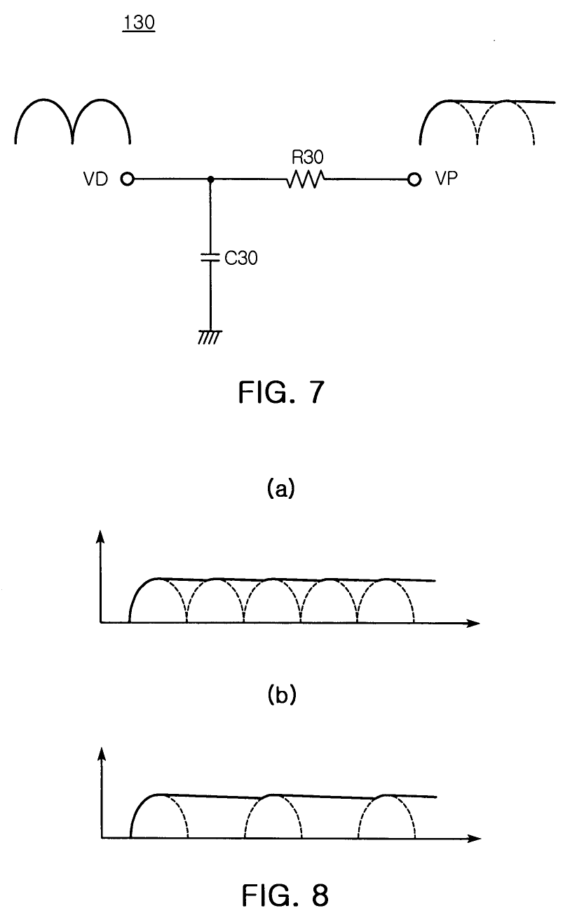

FIG. 7 is a circuit diagram of the peak detector according to the present invention.

Referring to FIG. 7, the peak detector 130 includes a capacitor C30 connected between the detection connection node ND and a ground, and a resistor R30 formed on a signal line between the capacitor C30 and an output end.

FIGS. 8 (a) and 8(b) illustrate waveforms of the peak voltage detected by the peak detector according to the present invention, in which FIG. 8(a) shows a waveform of the peak voltage detected when both lamp wires are open, and FIG. 8(b) shows a waveform of the peak voltage detected when one of both lamp wires is open.

Hereinafter, the operations and effects of the present invention will be described in detail with reference to the drawings.

The operations of a voltage feedback circuit for an LCD backlight inverter, according to the present invention, will be described with reference to FIGS. 6 through 8.

Referring to FIG. 6, the voltage feedback circuit according to the present invention is applied to the LCD backlight inverter including a plurality of first and second transformers T1 and T2 driven oppositely to each other. The voltage feedback circuit detects a drive voltage supplied to a lamp when the lamp is open, so as to feed back the detected voltage to a controller (not shown), and thereby the controller regulates the drive voltage of the lamp according to the detected voltage.

The first voltage detector 110 of the voltage feedback circuit detects the first drive voltage V1 from the first transformer T1. In addition, the second voltage detector 120 of the voltage feedback circuit detects the second drive voltage V2 from the second transformer T2.

In detail, the first voltage detector 110 includes first and second capacitors Cii and C12 connected in series with each other between an output end of the first transformer and a ground, and a first diode D11 rectifying the voltage at a first connection node N1 of the first and second capacitors C11 and C12. The first voltage detector 110 further includes a second diode D12 having a cathode connected to an anode of the first diode D11 and an anode connected to the ground. The second diode D12 works as a constant voltage device regulating the voltage to a certain level at the first connection node N1 of the first and second capacitors C11 and C12.

In addition, the second voltage detector 120 includes third and fourth capacitors C21 and C22 connected in series with each other between an output end of the second transformer and a ground, and a third diode D21 rectifying the voltage at a second connection node N2 of the third and fourth capacitors C21 and C22. The second voltage detector 120 further includes a fourth diode D22 having a cathode connected to an anode of the third diode D21 anda nanodeconnected tothe ground. The fourthdiode D22 works as a constant voltage device regulating the voltage to a certain level at the second connection node N2 of the third and fourth capacitors C21 and C22.

Next, the peak detector 130 of the present invention detects a peak of the voltage VD detected at the detection connection node ND to which the output end of the first voltage detector 110 and the output end of the second voltage detector 120 are connected. This will be explained with reference to FIG. 7.

Then, the voltage adjustor 140 adjusts a peak voltage VP from the peak detector 130 according to a predetermined voltage ratio.

As shown in FIG. 6, the voltage adjustor 140 is embodied as a voltage dividing circuit including resistors R41 and R42 and a capacitor C41, thereby adjusting the peak voltage detected by the peak detector 130 according to a predetermined voltage ratio.

Next, the error detector 150 of the present invention detects a difference voltage between an adjusted voltage VA from the voltage adjustor 140 and a predetermined reference voltage Vref.

More specifically, the error detector 150 includes an operation amplifier OP1 having a noninversion end to which the reference voltage Vrefis inputted and an inversion end to which the adjusted voltage VA is inputted, with an output end and the inversion end thereof connected bya capacitor C51. This allows the operation amplifier OP1 to detect the difference voltage (VA-Vref) between the adjusted voltage VA and the reference voltage Vref.

According to this difference voltage, the controller controls the power switch by one of a pulse width modulation method and a pulse frequency modulation method.

The peak detector 130 will now be explained in greater detail with reference to FIGS. 6 and 7.

With reference to FIGS. 6 and 7, the peak detector 130 may include a capacitor C30 and a resistor R30 as shown in FIG. 7. In this case, since the detected voltage VD is smoothed by a resistor-capacitor circuit of the capacitor C30 and the resistor R30, a direct-current voltage corresponding to the peak voltage of the detected voltage VD is outputted from the peak detector 130.

As described above, the peak detector 130 according to the present invention may detect the peak voltage even when the detected voltage VD is inputted in a form of full-wave rectification as shown in FIG. 8(a), or inputted in a form of half-wave rectification as shown in FIG. 8(b).

By such a peak detector according to the present invention, the drive voltage may be accurately detected when one of a pair of lamp wires is open or both wires are open. Thus, even when one of both wires is open, the controller does not continuously increase the drive voltage, preventing an over-voltage, thereby obviating destruction of the transformer.

According to the present invention as set forth above, a voltage feedback circuit applied to an LCD monitor or an LCD television accurately detects a drive voltage of a lamp when the lamp is open, regardless of the number of open wires, thereby preventing an over-voltage usually caused when one of a pair of lamp wires is open and obviating destruction of a transformer by the over voltage.

Whilethe presentinvention hasbeen shownand described in connection with the exemplary embodiments, it will be apparent to those skilled in the art that modifications and variations may be made without departing from the spirit and scope of the invention as defined by the appended claims.

What is claimed is:

1. A voltage feedback circuit for a liquid crystal display backlight inverter comprising a plurality of first and second transformers driven oppositely to each other, the voltage feedback circuit comprising:
a first voltage detector detecting a first drive voltage from a first transformer;
a second voltage detector detecting a second drive voltage from a second transformer;
a peak detector detecting a peak of a voltage detected at a detection connection node at which an output end of the first voltage detector and an output end of the second voltage detector are connected;
a voltage adjustor adjusting the peak voltage from the peak detector according to a predetermined voltage ratio; and
an error detector detecting a difference voltage between the detected voltage from the voltage adjustor and a predetermined reference voltage.

2. The voltage feedback circuit of claim 1, wherein the first voltage detector comprises:
first and second capacitors connected in series with each other between an output end of the first transformer and a ground;
a first diode having an anode connected to a first connection node to which the first and second capacitors are connected, the first diode rectifying a voltage at the first connection node; and
a second diode having a cathode connected to the anode of the first diode and an anode connected to the ground.

3. The voltage feedback circuit of claim 1, wherein the second voltage detector comprises:
third and fourth capacitors connected in series with each other between an output end of the second transformer and a ground;
a third diode having an anode connected to a second connection node to which the third and fourth capacitors are connected, the third diode rectifying a voltage at the second connection node; and
a fourth diode having a cathode connected to the anode of the third diode and an anode connected to the ground.

4. The voltage feedback circuit of claim 1, wherein the peak detector comprises:
a capacitor connected between the detection connection node and a ground; and
a resistor formed on a signal line between the capacitor and an output end.
